(19) United States
(12) Patent Application Publication
(10) Pub. No.: US 2012/0306930 A1
(43) Pub. Date: Dec. 6, 2012

(54) TECHNIQUES FOR ZOOMING IN AND OUT WITH DYNAMIC CONTENT

(75) Inventors: KEVIN W. DECKER, San Jose, CA (US); Damian Kaleta, San Jose, CA (US)

(73) Assignee: APPLE INC., Cupertino, CA (US)

(21) Appl. No.: 13/222,804

(22) Filed: Aug. 31, 2011

Related U.S. Application Data
(60) Provisional application No. 61/493,486, filed on Jun. 5, 2011.

(51) Int. Cl. G09G 5/00

(52) U.S. Cl. 345/667

(57) ABSTRACT

Methods and apparatuses for providing a zoom experience. A snapshot of content is generated in response to detection of initiation of a zoom control input. A zoom operation is performed based on the zoom control input on the snapshot to provide a post-zoom snapshot. The snapshot is displayed while performing the zooming. The content is rendered to provide an amount of zoom as indicated by the zoom control input to provide a post-zoom rendering. The post-zoom is blended with the snapshot and the post-zoom rendering to provide a final image. The final image is displayed.

This U.S. patent application claims priority to U.S. Provisional Patent Application No. 61/493,486 (Attorney Docket Number 4860P11597Z/P11597USP1), entitled, “Techniques For Zooming In And Out With Dynamic Content” filed Jun. 5, 2011.

### TECHNICAL FIELD

Embodiments of the invention relate to presentation of images with an electronic device. More particularly, embodiments of the invention relate to techniques for providing an ability to zoom in and out from and image that is presented on an electronic device.

### BACKGROUND

With the advance of browser technologies and network infrastructures, more and more content or applications may be accessed via a browser application. In order to improve the usability of this content, some browser applications provide the ability to zoom in and out to enlarge selected sections of the content. Various control mechanisms may be used to control the zooming.

### BRIEF DESCRIPTION OF THE DRAWINGS

The invention is illustrated by way of example, and not by way of limitation, in the figures of the accompanying drawings in which like reference numerals refer to similar elements.

FIG. 1 is a block diagram of one embodiment of an electronic system.

FIG. 2 is a block diagram of a system to present pages of data.

FIG. 3 is a flow diagram of one embodiment of a technique to provide a zoom in experience utilizing a snapshot.

FIG. 4 is a flow diagram of one embodiment of a technique to provide a zoom out experience utilizing a snapshot.

FIG. 5 is a flow diagram of one embodiment of a zoom in requiring panning and/or scrolling.

FIG. 6 is a block diagram of one embodiment of a zoom control agent

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

When a user of an electronic device (e.g., computer system, tablet device, smartphone, kiosk) utilizes a browser to access information presented as a page the user may wish to see a portion of a page with more or less detail. That is, the user may wish to zoom in or to zoom out. As discussed above, under certain conditions a user may be provided with a less than optimal experience. Described herein are techniques to improve the user experience when zooming in or zooming out of a view of a page.

Various mechanisms may be used to control zooming in both speed and amount. For example, a pinching motion on a control pad maybe used where the user moving fingers toward each other controls a zoom in and the user moving fingers away from each other controls a zoom out. Other mechanisms to control zooming can include, for example, tapping a control pad, rotating a wheel (e.g., on a mouse or other input device), use of arrow or other keys on a keyboard, manipulation of a slider on a graphical user interface, etc.

A user's experience is most enjoyable when interactions are natural and intuitive. Thus, when zooming, a smooth and natural zooming of the image is preferred. However, the manipulation of images required to provide zooming may be enough that there may not be enough computational power and/or bandwidth to provide an immediate smooth zoom. In one embodiment, snapshot images may be used during the zooming process while the content to be displayed is processed. When the processing is complete, the snapshot is replaced by the zoomed page.

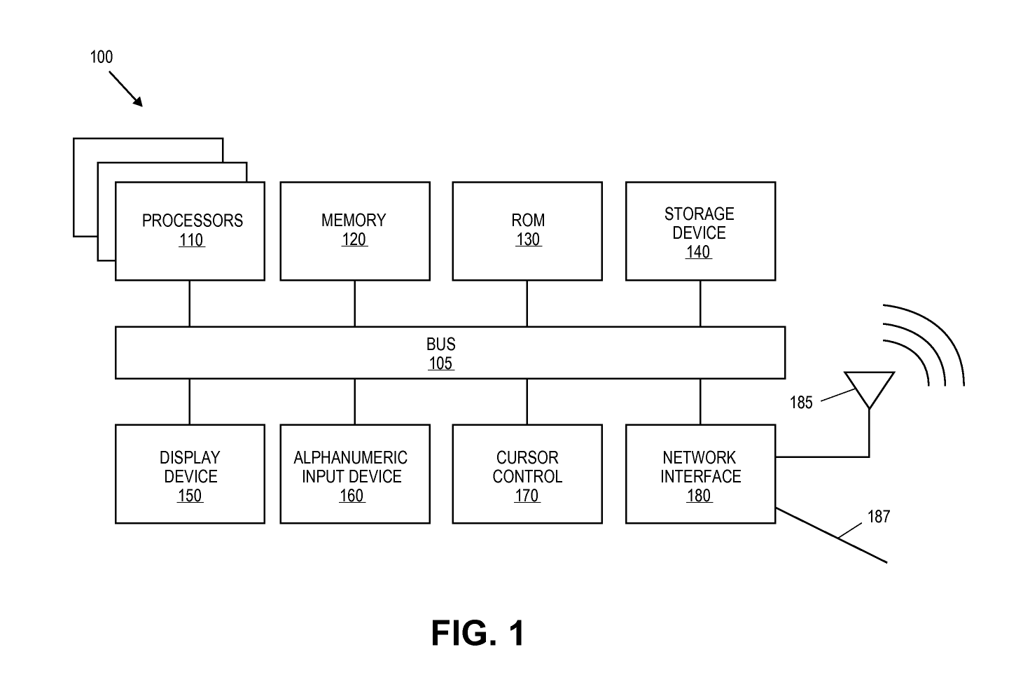

FIG. 1 is a block diagram of one embodiment of an electronic system. The electronic system illustrated in FIG. 1 is intended to represent a range of electronic systems (either wired or wireless) including, for example, desktop computer systems, laptop computer systems, tablet devices, cellular telephones, personal digital assistants (PDAs) including cellular-enabled PDAs, set top boxes. Alternative electronic systems may include more, fewer and/or different components.

Electronic system 100 includes bus 105 or other communication device to communicate information, and processor 110 coupled to bus 105 that may process information. While electronic system 100 is illustrated with a single processor, electronic system 100 may include multiple processors and/or co-processors. Electronic system 100 further may include random access memory (RAM) or other dynamic storage device 120 (referred to as main memory), coupled to bus 105 and may store information and instructions that may be executed by processor 110. Main memory 120 may also be used to store temporary variables or other intermediate information during execution of instructions by processor 110.

Electronic system 100 may also include read only memory (ROM) and/or other static storage device 130 coupled to bus 105 that may store static information and instructions for processor 110. Data storage device 140 may be coupled to bus 105 to store information and instructions. Data storage device 140 such as a magnetic disk or optical disc and corresponding drive may be coupled to electronic system 100.

Instructions are provided to memory from a storage device, such as magnetic disk, a read-only memory (ROM) integrated circuit, CD-ROM, DVD, via a remote connection (e.g., over a network via network interface 130) that is either wired or wireless providing access to one or more electronically-accessible media, etc. In alternative embodiments, hard-wired circuitry can be used in place of or in combination with software instructions. Thus, execution of sequences of instructions is not limited to any specific combination of hardware circuitry and software instructions.

A computer-readable medium includes any mechanism that provides content (e.g., computer executable instructions) in a form readable by an electronic device (e.g., a computer, a personal digital assistant, a cellular telephone). For example, a computer-readable medium may include read only memory (ROM); random access memory (RAM); magnetic disk storage media; optical storage media; flash memory devices; etc.

Electronic system 100 may also be coupled via bus 105 to display device 150, such as a cathode ray tube (CRT) or liquid crystal display (LCD), to display information to a user. Alphanumeric input device 160, including alphanumeric and other keys, may be coupled to bus 105 to communicate information and command selections to processor 110. Another type of user input device is cursor control 170, such as a mouse, a trackball, or cursor direction keys to communicate direction information and command selections to processor 110 and to control cursor movement on display 150.

Electronic system 100 further may include network interface(s) 180 to provide access to a network, such as a local area network. Network interface(s) 180 may include, for example, a wireless network interface having antenna 185, which may represent one or more antenna(e). Network interface(s) 180 may also include, for example, a wired network interface to communicate with remote devices via network cable 187, which may be, for example, an Ethernet cable, a coaxial cable, a fiber optic cable, a serial cable, or a parallel cable.

In one embodiment, network interface(s) 180 may provide access to a local area network, for example, by conforming to IEEE 802.11b and/or IEEE 802.11g standards, and/or the wireless network interface may provide access to a personal area network, for example, by conforming to Bluetooth standards. Other wireless network interfaces and/or protocols can also be supported.

IEEE 802.11b corresponds to IEEE Std. 802.11b-1999 entitled “Local and Metropolitan Area Networks, Part 11: Wireless LAN Medium Access Control (MAC) and Physical Layer (PHY) Specifications: Higher-Speed Physical Layer Extension in the 2.4 GHz Band,” approved Sep. 16, 1999 as well as related documents. IEEE 802.11g corresponds to IEEE Std. 802.11g-2003 entitled “Local and Metropolitan Area Networks, Part 11: Wireless LAN Medium Access Control (MAC) and Physical Layer (PHY) Specifications, Amendment 4: Further Higher Rate Extension in the 2.4 GHz Band,” approved Jun. 27, 2003 as well as related documents. Bluetooth protocols are described in “Specification of the Bluetooth System: Core, Version 1.1,” published Feb. 22, 2001 by the Bluetooth Special Interest Group, Inc. Associated as well as previous or subsequent versions of the Bluetooth standard may also be supported.

In addition to, or instead of, communication via wireless LAN standards, network interface(s) 180 may provide wireless communications using, for example, Time Division, Multiple Access (TDMA) protocols, Global System for Mobile Communications (GSM) protocols, Code Division, Multiple Access (CDMA) protocols, and/or any other type of wireless communications protocol.

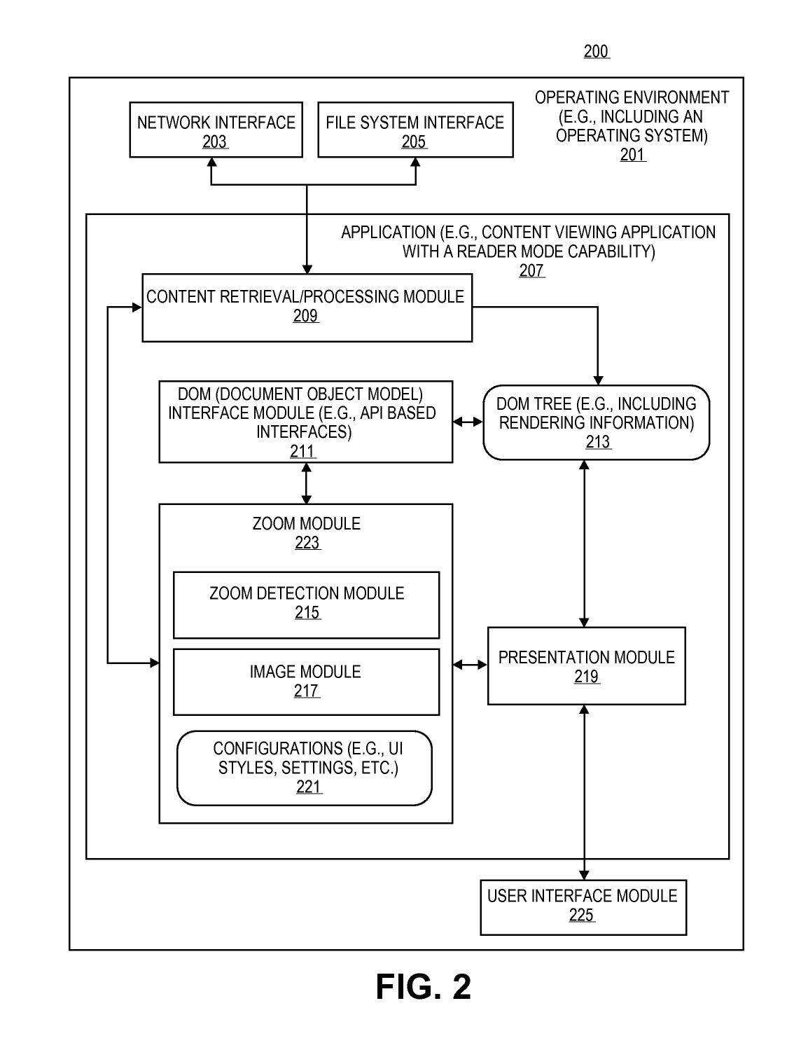

FIG. 2 is a block diagram illustrating one embodiment of a system 200, such as in a data processing system or a computer, for presenting web content in a browser. System 201 can be a computer operating environment including an operating system and/or an application 207, such as a content viewing application to present the web content. Application 207 may be a browser capable of navigating to and from pages and to provide zooming functionality as described herein.

Content retrieval/processing module 209 may retrieve a document or content from a network via a network interface 203 (e.g. from a remote web server) or a file system locally or remotely coupled via file system interface 205. In one embodiment, the content received may be a hypertext based document encoded in languages such as HTML (Hyper Text Markup Language), XML (Extensible Markup Language), or other markup languages, etc.

Content retrieval/processing module 209 can process (e.g. parse) a document to identify document elements and generate or build a DOM tree or DOM structure 213 out of the document elements. A document element may be a hypertext element such as an HTML tag in an HTML document. In one embodiment, DOM tree 213 may represent a topological or structural relationship among the document elements. Each node in DOM tree 213 of a document may correspond to one document element of the document. Document elements may include document content and/or layout specifications, such as size attributes associated with HTML tags in an HTML document, for presenting the document content, e.g. via presentation module 219 to display a user interface rendering a web page on a display screen via user interface module 225.

In one embodiment, content retrieval/processing module 209 may include a rendering engine to generate rendering information, such as layout parameters (e.g. sizing data of a rectangular area) for each node in DOM tree 213 for presenting a corresponding document. The rendering engine can make rendering decisions according to configurations including layout specifications in a document, user interface settings for application 207 and/or other system settings, etc. A rendered DOM tree may represent web content such as a web page presented by a browser.

In one embodiment, application 207 may include zoom module 223 to provide zoom functionality as described herein, which may operate with DOM interface module 211. Zoom module 223 may include zoom detection module 215 to detect zoom events. Image module 217 may generate and/or manage snapshots that may be utilized as described herein. Mode configuration module 221 may allow a user to set parameters related to transitions, for example, a cache size to be used, a transition sensitivity, etc.

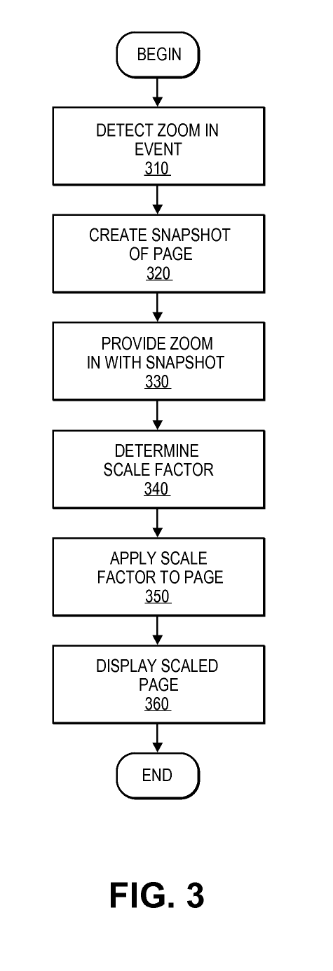

FIG. 3 is a flow diagram of one embodiment of a technique to provide a zoom in experience utilizing a snapshot. In one embodiment, the pages are provided by a browser application and the zoom in is in response to user input. The user input my be provided by use of buttons or other graphical components, or by user gestures (e.g., a pinching motion) provided through an input pad or touch screen, or any combination thereof. Other input mechanisms can also be supported.

A zoom in event is detected, 310. In one embodiment, detecting a zoom event corresponds to monitoring input devices that may be utilized to control a zoom event and reacting to the beginning of an input that will cause a zoom. Using the pinch control example, when a user places two fingers on a control pad, the user is in position to start a zoom event. If the user moves the fingers apart, for example, this may cause a zoom in. Thus, in response to the beginning of the finger movement, a zoom event may be detected.

In response to the detection of the zoom event, the browser (or other system entity) may generate a snapshot of the page being displayed, 320. The snapshot replaces the page in the browser. The snapshot is then used as the image that is zoomed, 330. That is, when the page is zoomed in response to the user input, it is the snapshot that is zoomed and not the page that had been displayed by the browser.

When the zooming is complete, the browser may determine a scale factor between the start of the zoom and the end of the zoom, 340. The scale factor indicates the amount of zoom that has been applied to the snapshot. The scale factor is applied to the page, 350. Once the scale factor has been applied to the page to provide the zoomed page that corresponds to the zoom applied to the snapshot may be displayed, 360.

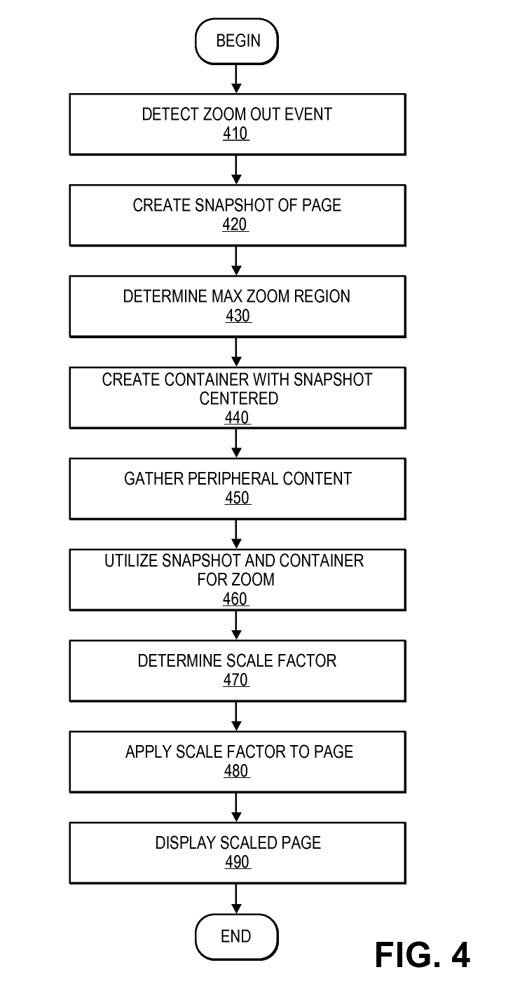

FIG. 4 is a flow diagram of one embodiment of a technique to provide a zoom out experience utilizing a snapshot. In one embodiment, the pages are provided by a browser application and the zoom in is in response to user input. The user input my be provided by use of buttons or other graphical components, or by user gestures (e.g., a pinching motion) provided through an input pad or touch screen, or any combination thereof. Other input mechanisms can also be supported.

A zoom out event is detected, 410. In one embodiment, detecting a zoom event corresponds to monitoring input devices that may be utilized to control a zoom event and reacting to the beginning of an input that will cause a zoom. Using the pinch control example, when a user places two fingers on a control pad, the user is in position to start a zoom event. If the user moves the fingers together, for example, this may cause a zoom out. Thus, in response to the beginning of the finger movement, a zoom event may be detected.

In response to the detection of the zoom event, the browser (or other system entity) may generate a snapshot of the page being displayed, 420. The snapshot replaces the page in the browser. The snapshot may be, for example, a bitmap or other graphical representation of the content of the page. In one embodiment, only the page content is represented in the snapshot and none of the surrounding elements (e.g., browser controls, window controls, etc.).

A maximum zoom region is determine, 430. The maximum zoom region may be determined based on the size of the page being view, the position of the user's fingers on the control pad, and/or using other information. The maximum zoom region represents the potential maximum zoom out, not necessarily the actual (or anticipated) zoom. The maximum zoom region allows the browser to be prepared for any zoom amount up to, and including, the maximum zoom.

A container is created based on the maximum zoom, 440. The snapshot is centered in the container so that when the user zooms out, the snapshot remains in the center of the browser window. In one embodiment, the region of the container not covered by the snapshot has a color matching the background of the page. Thus, as the user zooms out the region around the snapshot appears to be the background of the page.

The peripheral content for the page is gathered, 450. The peripheral content is the content that is part of the larger page being viewed, but is not visible to the user at the time the zoom event is initiated. In one embodiment, this content is retrieved from the window server; however, it may be retrieved from any relevant source.

In one embodiment, a first snapshot is generated from a window server because this content is more quickly provided. This snapshot may be replaced with a higher resolution web page snapshot when the higher resolution web page snapshot is available. Use of the window server content allows for a quicker transition to use of the snapshot, which provides a more immediate zoom response.

The snapshot and the container with the background matching the background of the page are used for zooming, 460. That is, when the page is zoomed in response to the user input, it is the snapshot that is zoomed and not the page that had been displayed by the browser.

When the zooming is complete, the browser may determine a scale factor between the start of the zoom and the end of the zoom, 470. The scale factor indicates the amount of zoom that has been applied to the snapshot and container. The scale factor is applied to the page, 480. Once the scale factor has been applied to the page to provide the zoomed page that corresponds to the zoom applied to the snapshot may be displayed, 490.

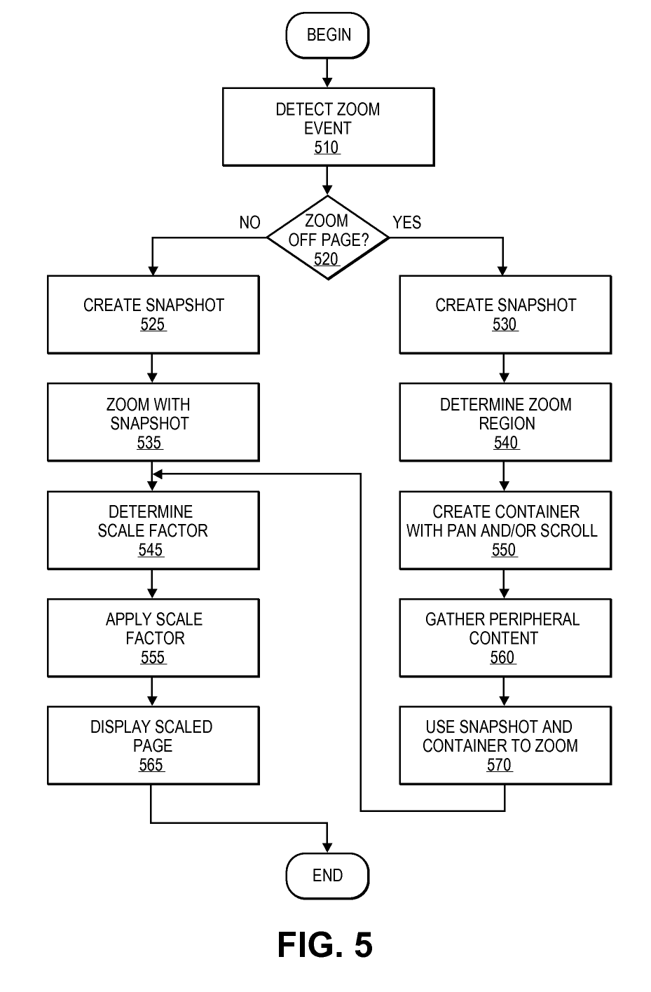

FIG. 5 is a flow diagram of one embodiment of a zoom in requiring panning and/or scrolling. When using some control mechanisms for zooming, a pan or scroll of a page may be required to provide the desired zoom. For example, if zooming in a pre-selected amount response to a tap or other command, the zoom may cause viewing of a region outside of page content. In one embodiment, an automatic scrolling or panning is applied to keep the view completely within the page.

A zoom out event is detected, 510. In one embodiment, detecting a zoom event corresponds to monitoring input devices that may be utilized to control a zoom event and reacting to the beginning of an input that will cause a zoom. Using a tap, or multi-tap, control example, when a user taps a specified number of fingers on a control pad, the user causes a zoom event.

The browser may determine if the zoom would include a region off of the page or out of the current view, 520. This may occur when zooming out as discussed above with respect to FIG. 4. It may also occur, for example, when zooming out near a page boundary or near the top of a window. Thus, automatic panning and/or scrolling may be utilized to keep the browser window within a region that provides content.

If the zoom does not go off the page, 520, the browser (or other system entity) may generate a snapshot of the page being displayed, 525. The snapshot replaces the page in the browser. The snapshot is then used as the image that is zoomed, 535. That is, when the page is zoomed in response to the user input, it is the snapshot that is zoomed and not the page that had been displayed by the browser.

When the zooming is complete, the browser may determine a scale factor between the start of the zoom and the end of the zoom, 545. The scale factor indicates the amount of zoom that has been applied to the snapshot. The scale factor is applied to the page, 555. Once the scale factor has been applied to the page to provide the zoomed page that corresponds to the zoom applied to the snapshot may be displayed, 565.

If the zoom does go off the page, 520, the browser (or other system entity) may generate a snapshot of the page being displayed, 530. The snapshot replaces the page in the browser. The snapshot may be, for example, a bitmap or other graphical representation of the content of the page. In one embodiment, only the page content is represented in the snapshot and none of the surrounding elements (e.g., browser controls, window controls, etc.).

A zoom region is determined, 540. The zoom region may be determined based on the size of the page being view, the position of the view within the page, and/or using other information. The zoom region represents the potential zoom out, not necessarily the actual (or anticipated) zoom. The zoom region allows the browser to be prepared for any zoom amount up to, and including, the maximum zoom.

A container is created based on the zoom region, 550. The snapshot is positioned in the container based on the panning and/or scrolling required to keep the view within the page content so that when the user zooms, the snapshot remains in the correct position within the browser window. In one embodiment, the region of the container not covered by the snapshot has a color matching the background of the page. Thus, as the user zooms out the region around the snapshot appears to be the background of the page.

The peripheral content for the page is gathered, 560. The peripheral content is the content that is part of the larger page being viewed, but is not visible to the user at the time the zoom event is initiated. In one embodiment, this content is retrieved from the window server; however, it may be retrieved from any relevant source.

In one embodiment, a first snapshot is generated from a window server because this content is more quickly provided. This snapshot may be replaced with a higher resolution web page snapshot when the higher resolution web page snapshot is available. Use of the window server content allows for a quicker transition to use of the snapshot, which provides a more immediate zoom response.

The snapshot and the container with the background matching the background of the page are used for zooming, 570. That is, when the page is zoomed in response to the user input, it is the snapshot that is zoomed and not the page that had been displayed by the browser.

When the zooming is complete, the browser may determine a scale factor between the start of the zoom and the end of the zoom, 545. The scale factor indicates the amount of zoom that has been applied to the snapshot and container. The scale factor is applied to the page, 555. Once the scale factor has been applied to the page to provide the zoomed page that corresponds to the zoom applied to the snapshot may be displayed, 565.

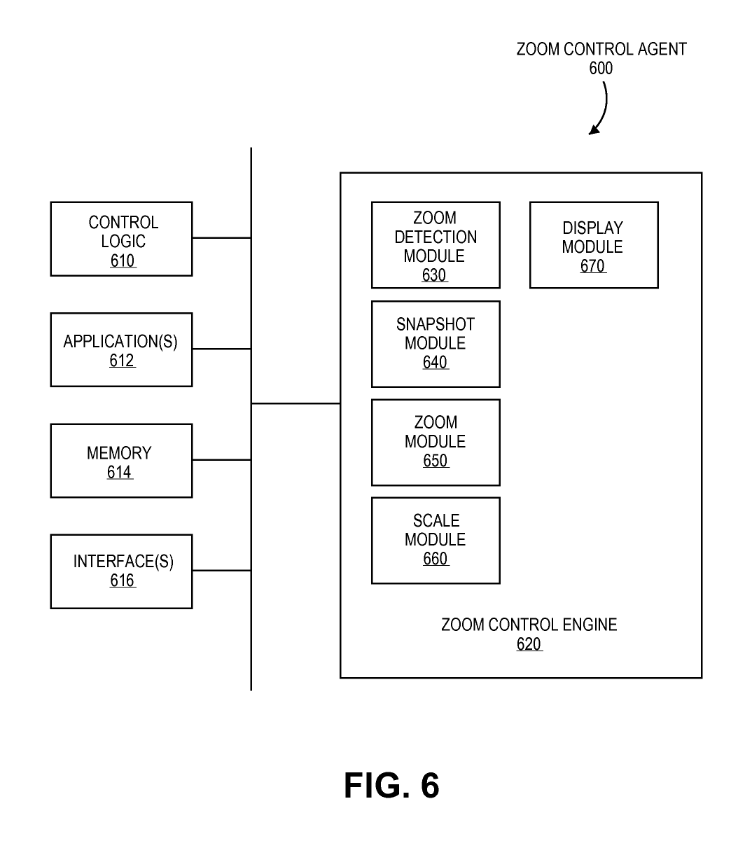

FIG. 6 is a block diagram of one embodiment of a zoom control agent that may be resident within, for example, a browser application, an electronic system providing a browser application, or a combination thereof. Zoom control agent 600 includes control logic 610, which implements logical functional control to direct operation of zoom control agent 600, and/or hardware associated with directing operation of zoom control agent 600. Logic may be hardware logic circuits and/or software routines. In one embodiment, zoom control agent 600 includes one or more applications 612, which represent code sequence and/or programs that provide instructions to control logic 610.

Zoom control agent 600 includes memory 614, which represents a memory device and/or access to a memory resource for storing data and/or instructions. Memory 614 may include memory local to zoom control agent 600, as well as, or alternatively, including memory of the host system on which zoom control agent 600 resides. Zoom control agent 600 also includes one or more interfaces 616, which represent access interfaces to/from (e.g., an input/output interface, application programming interface) zoom control agent 600 with regard to entities (electronic or human) external to zoom control agent 600.

Zoom control agent 600 also includes zoom control engine 620, which represents one or more functions that enable zoom control agent 600 to provide the zooming in and/or out on pages as described herein. Example modules that may be included in zoom detection module 630, snapshot module 640, zoom module 650, scale module 660 and display module 670. Each of these modules may further include other modules to provide other functions. As used herein, a module refers to routine, a subsystem, etc., whether implemented in hardware, software, firmware or some combination thereof.

Zoom detection module 630 may function to determine when a zoom event is initiated. As discussed above, zoom events may be initiated by gestures or other control pad interactions, use of an input device such as a mouse with a wheel or control pad, interaction with graphical user interface elements, etc. Zoom detection module 630 may communicate to one or more other modules the beginning of a zoom event.

Snapshot module 640 may function to generate and manage snapshots that may be utilized for zooming as described herein. Snapshot module 640 may create a snapshot image of the contents of a page in response to an indication of a zoom event from zoom detection module 630. The snapshot may be displayed for zoom purposes as well as stored for other uses.

Zoom module 650 may function to provide the zoom operation on the snapshot generated by snapshot module 640. Zoom module 650 may provide a zoom in and/or a zoom out as described herein utilizing the snapshot image.

Scale module 660 may interact with zoom module to determine a scale factor corresponding to the zoom operation. Scale module 660 may also communicate the scale factor to display module 670 or other component. Display module 670 functions to determine and control whether the snapshot image is displayed or the page is displayed. Further, display module 670 may provide panning and/or scrolling information related to position within the page.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

What is claimed is:

1. A method comprising:
generating a snapshot of content in response to detection of initiation of a zoom control input;
performing a zoom operation based on the zoom control input on the snapshot to provide a post-zoom snapshot;
displaying the snapshot while performing the zooming;
rendering the content to provide an amount of zoom as indicated by the zoom control input to provide a post-zoom rendering;
blending the post-zoom snapshot and the post-zoom rendering to provide a final image; and
displaying the final image.

2. The method of claim 1 wherein the zoom control input comprises a finger double-tap on control interface of an electronic device.

3. The method of claim 1 wherein the zoom control comprises a finger pinching motion.

4. The method of claim 3 wherein the finger pinching motion comprises moving fingers closer together to cause a zoom in.

5. The method of claim 3 wherein the finger pinching motion comprises moving fingers farther apart to cause a zoom out.

6. The method of claim 2 wherein the control interface comprises a control pad of a laptop computer.

7. The method of claim 2 wherein the control interface comprises a control pad communicatively coupled with a computing device.

8. The method of claim 2 wherein the control interface comprises a touch screen of a tablet device.

9. The method of claim 1 further comprising applying a scrolling operation to the snapshot to compensate for zooming beyond snapshot edges.

10. An article of manufacture comprising a computer-readable medium having stored thereon instructions that, when executed by one or more processors, cause the one or more processors to:
generate a snapshot of content in response to detection of initiation of a zoom control input;
perform a zoom operation based on the zoom control input on the snapshot to provide a post-zoom snapshot;
display the snapshot while performing the zooming;
render the content to provide an amount of zoom as indicated by the zoom control input to provide a post-zoom rendering;
blend the post-zoom snapshot and the post-zoom rendering to provide a final image; and
display the final image.

11. The article of claim 10 wherein the zoom control input comprises a finger double-tap on control interface of an electronic device.

12. The article of claim 10 wherein the zoom control comprises a finger pinching motion.

13. The article of claim 12 wherein the finger pinching motion comprises moving fingers closer together to cause a zoom in.

14. The article of claim 12 wherein the finger pinching motion comprises moving fingers farther apart to cause a zoom out.

15. The article of claim 11 wherein the control interface comprises a control pad of a laptop computer.

16. The article of claim 11 wherein the control interface comprises a control pad communicatively coupled with a computing device.

17. The article of claim 11 wherein the control interface comprises a touch screen of a tablet device.

18. The article of claim 10 further comprising instructions that, when executed, cause the one or more processors to apply a scrolling operation to the snapshot to compensate for zooming beyond snapshot edges.

19. An apparatus comprising:
means for generating a snapshot of content in response to detection of initiation of a zoom control input;
means for performing a zoom operation based on the zoom control input on the snapshot to provide a post-zoom snapshot;
means for displaying the snapshot while performing the zooming;
means for rendering the content to provide an amount of zoom as indicated by the zoom control input to provide a post-zoom rendering;
means for blending the post-zoom snapshot and the post-zoom rendering to provide a final image; and
means for displaying the final image.

20. The apparatus of claim 19 further comprising means for applying a scrolling operation to the snapshot to compensate for zooming beyond snapshot edges.

21. A system comprising:
a display device;
a zoom control agent coupled with the display device, the zoom control agent to generate a snapshot of content in response to detection of initiation of a zoom control input, to perform a zoom operation based on the zoom control input on the snapshot to provide a post-zoom snapshot, to display the snapshot while performing the zooming, to render the content to provide an amount of zoom as indicated by the zoom control input to provide a post-zoom rendering, to blend the post-zoom snapshot and the post-zoom rendering to provide a final image, and to display the final image.

22. The system of claim 21 wherein the zoom control input comprises a finger double-tap on control interface of an electronic device.

23. The system of claim 21 wherein the zoom control comprises a finger pinching motion.

24. The system of claim 23 wherein the finger pinching motion comprises moving fingers closer together to cause a zoom in.

25. The system of claim 23 wherein the finger pinching motion comprises moving fingers farther apart to cause a zoom out.

26. The system of claim 22 wherein the control interface comprises a control pad of a laptop computer.

27. The system of claim 22 wherein the control interface comprises a control pad communicatively coupled with a computing device.

28. The system of claim 22 wherein the control interface comprises a touch screen of a tablet device.
